(19) United States
(12) Patent Application Publication
(10) Pub. No.: US 2005/0221103 A1
(43) Pub. Date: Oct. 6, 2005

(54) Polyimide complex sheet

(75) Inventors: Shuichi Maeda, Yamaguchi (JP); Yukinori Kohama, Yamaguchi (JP); Masahiro Naiki, Yamaguchi (JP); Tetsuji Hirano, Yamaguchi (JP); Masayuki Kinouchi, Yamaguchi (JP)

Correspondence Address: NIXON PEABODY, LLP, 401 9TH STREET, NW, SUITE 900, WASHINGTON, DC, 20004-2128, US

(73) Assignee: Ube Industries, Ltd., Ube-shi (JP)

(21) Appl. No.: 11/039,820

(22) Filed: Jan. 24, 2005

(30) Foreign Application Priority Data
Jan. 22, 2004 (JP) 2004-014132

(51) Int. Cl. B05D 3/02; B32B 1/00

(52) U.S. Cl. 428/473.5; 428/333; 427/226

(57) ABSTRACT

A polyimide complex sheet is composed of an aromatic polyimide film, an intervening layer and a thin metal oxide layer in which the intervening layer is formed of a mixture of the metal oxide and the aromatic polyimide under such condition that a ratio of the metal oxide to the aromatic polyimide increases from a side facing the polyimide film to a side facing the metal oxide layer and the intervening layer is united to the polyimide film and the metal oxide layer under such condition that the metal oxide layer is not peelable from the polyimide film without breakage of the metal oxide layer.

### FIELD OF THE INVENTION

The present invention relates to a polyimide complex sheet comprising an aromatic polyimide film and a thin metal oxide layer.

### BACKGROUND OF THE INVENTION

An aromatic polyimide film has excellent characteristics in its heat resistance, mechanical strength, electric properties, resistance to alkali and acid, and flame resistance, and hence is widely utilized, for instance, to produce a flexible printable circuit board and a tape-automated bonding board. The aromatic polyimide film is also employed as a heat-controllable element of a space vehicle.

In view of the excellent characteristics of the aromatic polyimide film in various properties, it has been proposed that a metal oxide layer is formed on the aromatic polyimide film to meet requirements in various industrial areas.

Japanese Patent Provisional Publication 8-139422 describes a flexible circuit board composed of a polyimide film, a thin metal oxide layer, and a metal film arranged in order. The thin metal oxide layer is formed on the polyimide film by sputtering.

Japanese Patent Provisional Publication 1-232034 describes a flexible complex film comprising a heat-resistant polymer film (such as a polyimide film) and a insulating layer of a metal oxide. The metal oxide layer is produced by a sol-gel process.

Japanese Patent Provisional Publication 2003-54950 describes an organic-inorganic complex sheet comprising an organic-inorganic mixture layer and a metal oxide surface layer. The organic-inorganic mixture layer is produced on an organic base sheet by a sol-gel process and a ratio of the organic material to the inorganic material varies in the thickness direction.

According to the studies of the present inventors, the metal oxide layer of the known complex sheets is not attached to the base polyimide film with enough boning force.

Accordingly, it is an object of the present invention to provide a polyimide complex film comprising an aromatic polyimide film and a thin metal oxide layer in which the thin metal oxide layer is firmly attached to the polyimide film with increased bonding force.

### SUMMARY OF THE INVENTION

The present invention resides in a polyimide complex sheet comprising an aromatic polyimide film and a thin metal oxide layer in which the intervening layer comprising a mixture of the metal oxide and the aromatic polyimide under such condition that a ratio of the metal oxide to the aromatic polyimide increases from a side facing the polyimide film to a side facing the metal oxide layer is arranged between the polyimide film and the metal oxide layer, the intervening layer being united to the polyimide film and the metal oxide layer under such condition that the metal oxide layer is not peelable from the polyimide film without breakage of the metal oxide layer.

The polyimide complex sheet of the invention can be manufactured by a process comprising the steps of:
preparing an aromatic polyimide precursor film comprising an aromatic polyamic acid and a polar organic solvent;
preparing a sol solution by hydrolyzing and condensing at least one metal-containing compound of the following formula:
   R¹ₙM(OR²)ₘ₋ₙ
   in which R¹ is a non-hydrolyzable group, R² is a hydrocarbyl group having 1 to 5 carbon atoms, M is a metal atom, m is a valency of the metal atom, and n is an integer satisfying the condition of 0≦n<m-1, in an aqueous organic solvent;
coating the sol solution on the aromatic polyimide precursor film; and
heating the aromatic polyimide precursor film coated with the sol solution to convert the aromatic polyimide precursor film into an aromatic polyimide film.

### BRIEF DESCRIPTION OF DRAWINGS

FIG. 1 is a schematic view of a structure of a polyimide complex sheet of the invention.

FIG. 2 illustrates results of ESCA measurements of a polyimide complex sheet of Example 1, in which relationships between atomic concentrations of C, N, O and Si and depth (measured starting from the metal oxide surface) of the complex sheet.

FIG. 3 illustrates results of ESCA measurements of a polyimide complex sheet of Example 2, in which relationships between atomic concentrations of C, N, O and Si and depth (measured starting from the metal oxide surface) of the complex sheet.

FIG. 4 illustrates results of ESCA measurements of a polyimide complex sheet of Example 3, in which relationships between atomic concentrations of C, N, O and Si and depth (measured starting from the metal oxide surface) of the complex sheet.

FIG. 5 illustrates results of ESCA measurements of a polyimide complex sheet of Comparative Example 1, in which relationships between atomic concentrations of C, N, O and Si and depth (measured starting from the metal oxide surface) of the complex sheet.

### DETAILED DESCRIPTION OF THE INVENTION

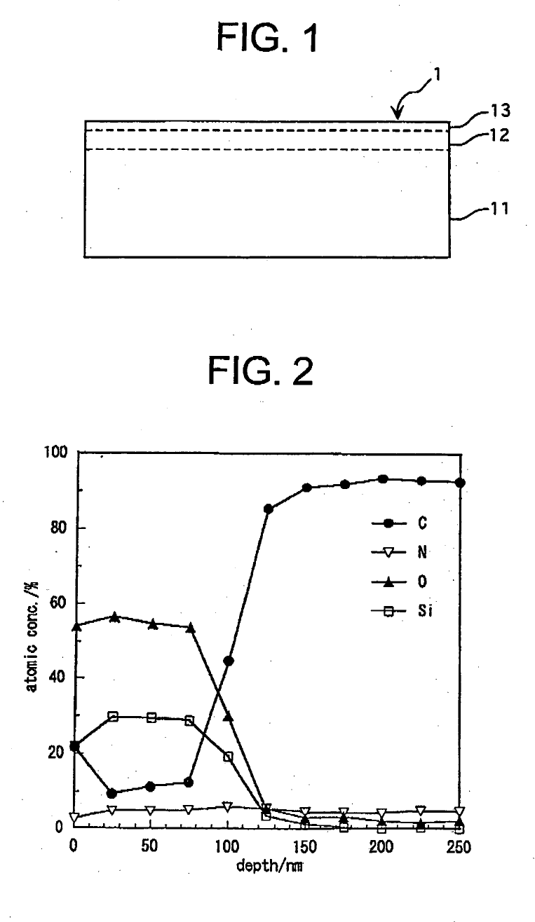

The polyimide complex sheet of the invention typically has a structure illustrated in FIG. 1, in which the polyimide complex sheet 1 comprises an aromatic polyimide film 11, an intervening layer 12, and a thin metal oxide layer 13.

The intervening layer 12 comprises a mixture of a metal oxide and an aromatic polyimide under such condition that a ratio of the metal oxide to the aromatic polyimide increases from a side facing the polyimide film 11 to a side facing the metal oxide layer 13. It is noted that there is no distinct interface between the polyimide layer 11 and the intervening layer 12. Further, there is no distinct interface between the intervening layer 12 and the metal oxide layer 13.

The intervening layer 12 is firmly attached to both of the polyimide layer 11 and the metal oxide layer 13. Therefore, the metal oxide layer 13 cannot be peeled from the polyimide film 11 without breakage of the metal oxide layer 12.

The thin metal oxide layer preferably has a thickness of 1 to 300 nm (more preferably 1 to 200 nm), and the intervening layer preferably has a thickness of 10 to 300 nm (more preferably 15 to 200 nm).

The polyimide film preferably has a thickness of 3 to 700 μm (more preferably 5 to 180 μm).

The polyimide complex sheet of the invention can be manufactured by a process comprising the steps of:
(1) preparing an aromatic polyimide precursor film comprising an aromatic polyamic acid and a polar organic solvent;
(2) preparing a sol solution by hydrolyzing and condensing at least one metal-containing compound of the following formula:
   R¹ₙM(OR²)ₘ₋ₙ
   in which R¹ is a non-hydrolyzable group, R² is a hydrocarbyl group having 1 to 5 carbon atoms, M is a metal atom, m is a valency of the metal atom, and n is an integer satisfying the condition of 0≦n<m-1, in an aqueous organic solvent;
(3) coating the sol solution on the aromatic polyimide precursor film; and
(4) heating the aromatic polyimide precursor film coated with the sol solution to convert the aromatic polyimide precursor film into an aromatic polyimide film.

The process for manufacturing a polyimide complex sheet of the invention is further described below.

In the step (1), an aromatic polyimide precursor film comprising an aromatic polyamic acid and a polar organic solvent is prepared.

The aromatic polyimide precursor film is prepared by the steps of producing a solution of an aromatic polyamic acid in a polar organic solvent and coating the solution on a support (e.g., metal sheet, a ceramic sheet, a plastic roll, a metal belt, or a roll to which a thin metal tape is supplied) and heating the coated solution until a certain portion of the solvent in the coated solution is evaporated and a certain portion of the polyamic acid is imidized. The aromatic polyimide precursor film preferably contains 20 to 40 wt. % of the polar organic solvent and has an imidization ratio of 8 to 50%.

The aromatic polyamic acid can be prepared by reacting and polymerizing an aromatic tetracarboxylic acid or its derivative, and an aromatic diamine at an equivalent molar ratio in a polar organic solvent. Examples of the aromatic tetracarboxylic acids include 3,3′,4,4′-biphenyltetracarboxylic acid, 2,3,3′,4′-biphenyltetracarboxylic acid, 3,3′,4,4′-benzophenonetetracarboxylic acid, 3,3′,4,4′-diphenylethertetracarboxylic acid, bis(3,4-dicarboxyphenyl)methane, 2,2-bis(3,4-dicarboxyphenyl)propane, pyromellitic acid, 1,4,5,8-naphthalenetetracarboxylic acid, and 3,4,9,10-perylenetetracarboxylic acid. Their derivatives such as their acid dianhydride and their esters also employable. Most preferred are 3,3′,4,4′-biphenyltetracarboxylic acid, pyromellitic acid, their acid dianhydride, and their esters. Examples of the aromatic diamines include 4,4′-diaminobenzene (i.e., p-phenylenediamine), 4,4′-diaminodiphenyl ether, 3,3′-diaminodiphenyl ether, 2,2-bis[4-(4-aminophenoxy)phenyl]propane, 1,3-bis(3-aminophenoxybenzene), 1,3-bis(4-aminophenoxybenzene) and dimethylphenylenediamine. Preferred is 4,4′-diaminobenzene. Other aromatic tetracarboxylic acids (or their derivatives) and aromatic diamines can be employed in combination with the above-mentioned aromatic tetracarboxylic acids (or their derivatives) and aromatic diamines. Examples of the polar organic solvents include amides such as N-methyl-2-pyrrolidone, N,N-dimethylacetamide, N,N-diethylacetamide, N,N-dimethylformamide, N,N-diethylformamide, and hexamethylsulforamide; sulfoxides such as dimethylsulfoxide and diethylsulfoxide; and sulfones such as dimethylsulfone and diethylsulfone. The polar organic solvents can be employed singly or in combination.

A total monomer content in the solution containing the aromatic tetracarboxylic acid and the aromatic diamine preferably is in the range of 5 to 40 wt. %, more preferably 6 to 35 wt. %, and most preferably 10 to 30 wt. %.

The polymerization reaction between the aromatic tetracarboxylic acid (or its derivative) and the aromatic diamine is carried out at a temperature of 100° C. or lower, preferably 80° C. or lower, for a period of 0.2 to 60 hours.

Thus produced polyamic acid solution preferably has a rotary viscosity of approx. 0.1 to 50,000 poises (at 30° C.), more preferably 0.5 to 30,000 poises, and most preferably 1 to 20,000 poises.

The polyimide precursor film can be manufactured by spreading the polyamic acid solution on an appropriate temporary support to give a solution film of approx. 10 to 2,000 μm thick, preferably 20 to 1,000 μm, and heating the solution film to 50-210° C., preferably 60-200° C., for instance, by applying a heated air or infrared rays, to give a self-supporting film. The self-supporting film is then separated from the temporary support.

The separated self-supporting film preferably shows a heating loss in the range of 20 to 40 wt. %, more preferably in the range of 24 to 38 wt. %. The imidation ratio in the self-supporting film preferably is in the range of 8 to 40%, more preferably 8 to 28%.

The heating loss of the self-supporting film is determined by once measuring a weight of the film (W1), then heating the film to 420° C. for 20 minutes, and measuring a weight of the heated film (W2) and by placing the measured weights in the following equation:
Heating loss (wt. %)={(W1−W2)/W1}×100

The imidation ratio of the self-supporting film can be determined by the Karl-Fischer method which is described in Japanese Patent Provisional Publication 9-316199.

The self-supporting film may contain a fine organic or inorganic filler in its surface portion or inner portion. The filler can be in the form of granules or plate.

The thin metal oxide film is prepared from a hydrolyzable metal-containing compound having the following formula (1):
R¹ₙM(OR²)ₘ₋ₙ
in which R¹ is a non-hydrolyzable group, R² is a hydrocarbyl group having 1 to 5 carbon atoms, M is a metal atom, m is a valency of the metal atom, and n is an integer satisfying the condition of 0≦m<m-1. When two or more R¹ are attached, they can be the same or different, and when two or more R² are present, they can be the same or different.

Examples of the non-hydrolyzable groups include hydrogen, alkyl groups such as methyl, ethyl, propyl, butyl and pentyl, aryl groups such as phenyl and 4-methylphenyl, and alkylene or alkylene groups which have at least one functional groups such as isocyanate, epoxy carboxyl, acid halide, acid anhydride, amino, thiol, vinyl, methacryl and halogen. The metal atom M can be Si, Al, Ti, Zr, In, Sn, Sb, Ba, Nb, or Y. Most preferred is Si. The hydrocarbyl group preferably is an alkyl group such as methyl, ethyl, propyl, isopropyl, butyl or pentyl.

Examples of the hydrolyzable metal-containing compounds are described below:
alkoxysilanes such as tetramethoxysilane, tetraethoxysilane, tetra-n-propoxysilane, tetraisopropoxysilane, tetra-n-butoxysilane, tetraisobutoxysilane, tetra-sec-butoxysilane, and tetra-tert-butoxysilane;
alkylalkoxysilanes such as methyltrimethoxysilane, methyltriethoxysilane, ethyltrimethoxysilane, methyltriethoxysilane, n-propyltrimethoxysilane, and n-propyltriethoxysilane;
arylalkoxysilanes such as phenyltrimethoxysilane and phenytriethoxysilane;
alkoxysilanes having isocyanato group such as 3-isocyanatopropyltriethoxysilane, 2-isocyanatoethyltriethoxysilane, 3-isocyanatopropylmethyldiethoxysilane, 2-isocyanatoethylethyldiethoxysilane, and di(3-isocyanatopropyl)diethoxysilane;
alkoxysilanes having epoxy group such as 3-glycidoxypropyltrimethoxysilane, 3-glycidoxypropyltriethoxysilane, 3-glycidoxypropylmethyldiethoxysilane, 2-(3,4-epoxycyclohexyl)ethyltriethoxysilane, and 3,4-epoxybutyltrimethoxysilane;
alkoxysilanes having carboxyl group such as carboxymethyltriethoxysilane, carboxyethyltriethoxysilane, and carboxymethyltri-n-propoxysilane;
alkoxysilanes having acid anhydride group such as 3-(triethoxysilyl)-2-methylpropylsuccinic anhydride, and 3-(trimethoxysilyl)-2-methylpropylsuccinic anhydride;
alkoxysilanes having acid halide group such as 2-(4-chlorosulfonylphenyl)ethyltriethoxysilane and 2-(4-chlorosulfonylphenyl)ethyltrimethoxysilane;
alkoxysilanes having amino group such as 3-amino-propyltrimethoxysilane, 3-aminopropyltriethoxysilane, 3-[2-(2-aminoethylaminoethyl)propyl]trimethoxysilane, 2-aminoethylaminomethyltrimethoxysilane, 3-(2-aminoethylaminopropyl)dimethoxymethylsilane, 3-(2-aminoethylaminopropyl)trimethoxysilane, 3-(2-aminoethylaminopropyl)triethoxysilane, 2-(2-aminoethylthioethyl)diethoxymethylsilane, 2-(2-aminoethylthioethyl)triethoxysilane, N-2-(aminoethyl)-3-aminopropyltriethoxysilane, N-2-(aminoethyl)-3-aminopropylmethyldiethoxysilane, and 3-phenylaminopropyltrinmethoxysilane;
alkoxysilanes having thiol group such as 3-mercaptopropyltriethoxysilane, 3-mercaptopropyltrimethoxysilane, 2-mercaptoethyltriethoxysilane, and 3-mercaptopropylmethyldiethoxysilane;
alkoxysilanes having vinyl group such as vinyltrimethoxysilane, vinyltriethoxysilane, and vinylmethyldiethoxysilane;
alkoxysilanes having methacryl group such as 3-methacryloxypropyltrimethoxysilane, 3-methacryloxypropyltriethoxysilane, and 3-methacryloxypropylmethyldiethoxysilane; and
alkoxysilanes having halogen group such as 3-chloropropyltriethoxysilane, 3-chloropropyltrimethoxysilane, 3-bromopropyltriethoxysilane, and 2-chloroethyltriethoxysilane.

As for other metal elements such as Al, Ti, Zr, In, Sn, Sb, Ea, Nb, Y and Mg, a number of compounds in which Si of the above-mentioned Si-containing compounds are replaced with one of these metal elements can be mentioned.

The compounds of the formula (1) can be employed singly or in combination.

Also employable are metal alkoxide compounds containing two or more metal elements in one molecule such as Mg[Al(iso-OC₃H₇)₄]₂, Ba[Zr(OC₂H₅)₉]₂, and (iso-C₃H₇O)₂Zr-[Al(iso-OC₃H₇)₄]₂, and metal alkoxide compounds of oligomer type which contain two or more repeating units such as tetramethoxysilane oligomer and tetraethoxysilane oligomer.

In the invention, the hydrolyzable metal-containing compound of the formula (1) is hydrolyzed and condensed to produce a sol. The hydrolysis and condensation of the compound of the formula (1) can be carried out according to the conventional method in which an organic solvent, a catalyst, and water are employed. The catalyst for the hydrolysis can be an acid catalyst such as hydrochloric acid, nitric acid, or oxalic acid. The acid catalyst can be employed in an amount of 0.01 to 5 mol. %, preferably 0.05 to 3 mol. %, per one mole of the compound of the formula (1). Water can be employable in an amount of 0.8 to 20 mol. %, preferably 1 to 15 mol %, per one mole of the compound of the fornula (1).

The hydrolysis can be carried out generally at 10-80° C., preferably 20-60° C. The sol solution is produced in an organic solvent such as acetone, methanol, ethanol, n-propanol, isopropanol, n-butanol, isobutanol, sec-butanol, tert-butanol, N-methyl-2-pyrrolidone, N,N-dimethylacetamide, N,N-dimethylformamide, 1,3-dimethyl-2-imidazolidinone, diglyme, triglyme, ethylene glycol, propylene glycol, hexylene glycol, ethylene glycol monomethyl ether, and γ-butyrolactone. The solvents can be employed singly or in combination. The solvent can be employed in an amount of 0.5 to 10 moles, preferably 0.8 to 8 moles, per one mole of the compound of the formula (1). The solvent of the sol solution can be replaced with a different solvent.

The sol solution is preferably diluted with a diluent before it is coated on the self-supporting aromatic polyimide precursor film. The diluent can be alcohol such as methanol or ethanol; amide such as N,N-dimethylacetamide; ketone such as acetone; ether such as tetrahydrofuran. Acetone is preferred.

For instance, the coating sol solution can be prepared by hydrolyzing and condensing a compound of the formula (1) and then diluted to give a sol solution containing 0.1 to 5 wt. % of a solid material.

The coating sol solution preferably contains an organic polymer having a low decomposition temperature. The organic polymer preferably decomposes at a temperature in the range of 300 to 450° C., at which the polyimide precursor film is heated to give the desired polyimide film. Examples of the organic polymers having a low decomposition temperature include polyether, polyester, polycarbonate, polyanhydride, polyamide, polyurethane, polyurea, polyacrylic acid, polyacrylate, polymethacrylic acid, polymethacrylate, polyacrylamide, polymethacrylamide, polyacrylonitrile, polymethacrylonitrile, polyolefin, polydiene, polyvinyl ether, polyvinyl ketone, polyvinylamide, polyvinylamine, polyvinyl ester, polyvinyl alcohol, polyvinyl halide, polyvinylidene halide, polystyrene, polysiloxane, polysulfide, polsulfone, polyimine, cellulose, starch, cyclodextrine, and organic polymers containing derivatives of these polymers. Copolymers of the monomers for the above-mentioned polymers and the monomer with other monomer can be employed.

Preferred are polyether, polyester, polycarbonate, polyanhydride, polyamide, polyurethane, polyurea, polyacrylic acid, polyacrylate, polymethacrylic acid, polymethacrylate, polyacrylamide, polymethacrylamide, polyvinylamide, polyvinylamine, polyvinyl ester, polyvinyl alcohol, and polyimine. More preferred are an aliphatic polyether, an aliphatic polyester, an aliphatic polycarbonate, and an aliphatic polyanhydride, and compositions containing one or more of these polymers. The organic polymer preferably has a number average molecular weight in the range of 100 to 1,000,000. The organic polymer can be added to the sol solution in an amount of 0 to 100 weight parts, preferably 0 to 10 weight parts, more preferably 0 to 5 weight parts, per one weight part of the solid content of the condensed metal oxide.

The sol solution can be coated on one or both surfaces of the aromatic polyimide precursor film by the conventional coating method such as gravure coat, spin coat, silk screening, dip coat, spray coat, bar coat, knife coat, roll coat, blade coat, and die coat.

The self-supporting polyimide precursor film coated with the sol solution is preferably heated to 0-50° C., preferably 15-40° C., for 0.1-3 hours, preferably 0.3-1 hour, for evaporating the sol solvent prior to thermal curing. The self-supporting polyimide precursor film with a dried coated layer is then fixed by means of pin-tenters, clips, or metal fixing aids, and heated first to 200-300° C., for 1-60 min., secondly to 300-370° C. for 1-60 min., and finally to 370-450° C. for 1-30 min, whereby converting the polyimide precursor film to the desired polyimide film. The heating procedures can be performed by means of known heating means such as a heating furnace and an infrared heating furnace. In the course of the three-step heating, the coated sol layer is converted to a complex layer comprising a surface metal oxide layer and an intermediate layer comprising a mixture of a metal oxide and an aromatic polyimide which is formed between the cured polyimide film and the surface metal-oxide layer. The intermediate layer comprises a mixture of the metal oxide and the aromatic polyimide under such condition that a ratio of the metal oxide to the aromatic polyimide increases from a side facing the polyimide film to a side facing the metal oxide layer is arranged between the polyimide film and the metal oxide layer. The intermediate layer is attached to the polyimide film and the metal oxide layer under such condition that the metal oxide layer is not peelable from the polyimide film without breakage of the metal oxide layer.

Thus manufactured polyimide complex sheet can have an elongation at break of 80% or higher, specifically 90% or higher, more specifically 95 to 120%, of the elongation at break of the corresponding aromatic polyimide film.

The polyimide complex sheet further can have an elongation at break of 15% or higher, and can have an elastic modulus in tension of 80% or higher, specifically 95% or higher, more specifically 95 to 120%, of the elastic modulus in tension of the aromatic polyimide film.

The polyimide complex sheet can have an elastic modulus in tension of 4.5 GPa or higher, specifically 5.3 GPa or higher, when the polyimide is prepared from a 3,3′,4,4′-biphenyltetracarboxylic acid or pyrromellitic acid, or their derivatives, and 4,4′-diaminobenzene or a combination of 4,4′-diaminobenzene and 4,4′-diaminodiphenyl ether.

The high bonding strength between the surface metal oxide layer and the intervening layer (i.e., intermediate layer) as well as the high bonding strength between the surface metal oxide layer and the polyimide base film can be observed by subjecting the complex sheet to a peeling test using an adhesive tape according to Grid Peeling Test defined in JIS K5400. In more detail, when the surface metal oxide layer of the polyimide complex sheet of the invention subjected to the peeling test, no exfoliation of the surface metal oxide layer is observed not only visually but also by means of IR analysis and SEM observation on the surface layer.

The elongation test was performed by means of a Tensilon tester (RTA-500) under the following conditions:
test piece: width 10.0 mm, space between chucks; 50.0 mm, temperature: 23° C., relative humidity: 50%, crosshead speed: 50 mm/min.

The graduation of the compositions of the surface layer, the intermediate layer, and the polyimide film can be observed by ESCA. Quantum 2000 (available from PHI) can be employed. In more detail, the complex polyimide sheet is etched starting from the surface layer in the depth direction using Ar gas at an etching rate of 3.55 nm/min., in terms of SiO₂ etching rate. By analyzing the composition of the etched surface using an electron gun (X ray-source: Al Kα), the variations of contents of carbon (C), nitrogen (N), oxygen (O) and silicon (Si) in the depth direction can be determined.

The invention is further described by the following examples.

### REFERENCE EXAMPLE 1

In a 300 mL-volume glass reaction vessel equipped with a stirrer, a nitrogen-gas inlet, and a reflux condenser were placed 183 g of N,N-dimethylacetamide and 0.1 g of a phosphoric acid compound (SEPAL 365-100, available from Chukyo Oil and Fat Co. Ltd.). In the vessel was further placed 10.81 g (0.100 mol.) p-phenylenediamine under stirring and introduction of nitrogen gas, and the content of the vessel was warmed at 50° C., whereby the content in the vessel was dissolved. To the resulting solution was slowly added 29.229 g (0.09935 mol.) of 3,4′,4,4′-biphenyltetracarboxylic dianhydride under careful attention to keep the content from production of exothermic reaction. Subsequently, the content was kept at 50° C. for 6 hours. Then, 0.2381 g (0.00065 mol.) of 3,3′,4,4′-biphenyltetracarboxylic dianhydride was further introduced in the vessel and dissolved in the vessel to give a polyamic acid solution in the form of a viscous brown liquid. The solution viscosity was approx. 1,500 poises (at 25° C.).

The polyamic acid solution was spread on a glass plate and dried at 120° C. for 60 minutes. A self-supporting polyimide precursor film (heating loss: 29.7 wt. %, imidation ratio: 27.5%) was obtained. The polyimide precursor film was separated from the glass plate and fixed to a frame. The polyimide precursor film was then heated to 250° C. by increasing the temperature of the film at a rate of 10° C./min. The film was then heated at 250° C. for 15 min. Thereafter, the film was heated to 350° C. by increasing the temperature at a rate of 10° C./min. The film was then heated at 350° C. for 30 min. Subsequently, the film was heated to 400° C. by increasing the temperature at a rate of 10° C./min., and finally heated at 400° C. for 15 min. Thus, a polyimide film having a thickness of approx. 50 μm was manufactured. The resulting polyimide film had the following properties:
elastic modulus in tension: 5.9 GPa
tensile strength at break: 280 MPa
elongation at break: 20%

### EXAMPLE 11

(1) Preparation of Coating Sol Solution

In a 50 ml-volume glass vessel were placed 14.8 g (0.056 mol.) of 3-(2-aminoethylaminopropyl)triethoxysilane, 10.1 g (0.56 mol) of water, 4.9 g (0.056 mol.) of N,N-dimethylacetamide, and 0.56 g (0.000056 mol.) of 0.1N hydrochloric acid. The content in the vessel was stirred at room temperature for 2 hours, to give a sol solution. The resulting sol solution was diluted with acetone to give a coating sol solution containing 1 wt. % of a solid content (in terms of metal oxide content).

(2) Manufacture of Polyimide Complex Sheet

The polyamic acid solution obtained in Reference Example 1 was coated on a glass plate. The coated layer was heated to 120° C. for 60 min., to give a self-supporting polyimide precursor film (heating loss: 29.7 wt. %, imidation ratio: 27.5%) was obtained. On the precursor film was coated the above-mentioned sol solution, and the coated solution was dried at room temperature for 15 min. The polyimide precursor film having the coated layer was separated from the glass plate and fixed to a frame. The polyimide precursor film having the coated layer was then heated to 250° C. by increasing the temperature at a rate of 10° C./min. The film was then heated at 250° C. for 15 min. Thereafter, the film was heated to 350° C. by increasing the temperature at a rate of 10° C./min. The film was then heated at 350° C. for 30 min. Thereafter, the film was heated to 400° C. by increasing the temperature at a rate of 100° C./min., and finally heated at 400° C. for 15 min. Thus, a polyimide complex sheet having a thickness of approx. 50 μm was manufactured. The resulting complex sheet had the following properties:
elastic modulus in tension: 6.3 GPa
tensile strength at break: 300 MPa
elongation at break: 22%
grid peeling test: no exfoliation of the metal oxide layer was observed.

The polyimide complex sheet was then subjected to ESCA measurement to determine variations of contents of C, N, O and Si in the depth direction from the surface metal oxide layer. The results are illustrated in FIG. 2. According to the results in FIG. 2, the surface silica layer had a thickness of approx. 80 nm, the intermediate layer comprising a mixture of silica and polyimide had a thickness of approx. 50 μnm.

### EXAMPLE 2

(1) Preparation of Coating Sol Solution

In a 50 mL-volume glass vessel were placed 10.0 g (0.056 mol.) of methyltriethoxysilane, 4.9 g (0.56 mol.) of N,N-dimethylacetamide, and 0.0071 g (0.000056 mol.) of oxalic acid dihydrate. The content in the vessel was stirred at room temperature for 2 hours, to give a sol solution. The resulting sol solution was diluted with acetone to give a coating sol solution containing 1 wt. % of a solid content (in terms of metal oxide content). To the coating sol solution was further added polyethylene glycol (M.W. 400) to give a sol solution containing the polyethylene glycol in an amount of 1 wt. %.

(2) Manufacture of Polyimide Complex Sheet

The procedures for manufacturing a polyimide complex sheet described in Example 1-(2) were repeated except for employing the sol solution obtained above, to give a polyimide complex sheet having a thickness of approx. 50 μm was manufactured. The resulting complex sheet had the following properties:
elastic modulus in tension: 6.2 GPa
tensile strength at break; 300 MPa
elongation at break: 21%
grid peeling test: no exfoliation of the metal oxide layer was observed.

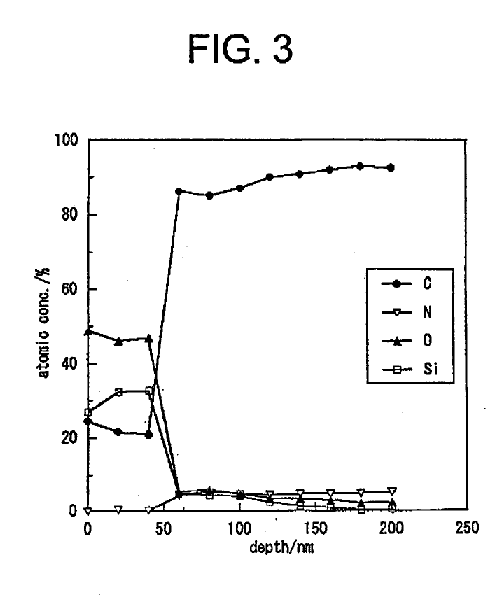

The polyimide complex sheet was then subjected to ESCA measurement to determine variations of contents of C, N, O and Si in the depth direction from the surface silica layer. The results are illustrated in FIG. 3. According to the results in FIG. 3, the surface silica layer had a thickness of approx. 40 nm, the intermediate layer comprising a mixture of silica and polyimide had a thickness of approx. 25 nm.

### EXAMPLE 31

(1) Preparation of Coating Sol Solution

In a 300 mL-volume glass vessel were placed 52.1 g (0.25 mol.) of tetraethoxysilane, 18.0 g (1.00 mol.) of water, 18.9 g (0.41 mol.) of ethanol, and 2.5 g (0.00025 mol.) of 0.1N hydrochloric acid. The content in the vessel was stirred at 60° C. for 2 hours, to give a homogeneous solution. From the resulting homogeneous solution was evaporated 45 g of a mixture of ethanol and water. To the residue was added 15 g of 1,3-dimethyl-2-imidazolidinone to give a coating sol solution containing 1 wt. % of a solid content (in terms of metal oxide content). To the coating sol solution was further added polyethylene glycol (M.W. 400) to give a sol solution containing the polyethylene glycol in an amount of 1 wt. %.

(2) Manufacture of Polyimide Complex Sheet

The procedures for manufacturing a polyimide complex sheet described in Example 1-(2) were repeated except for employing the sol solution obtained above, to give a polyimide complex sheet having a thickness of approx. 50 μm was manufactured. The resulting complex sheet had the following properties;
elastic modulus in tension: 6.4 GPa
tensile strength at break: 310 MPa
elongation at break: 22%
grid peeling test: no exfoliation of the metal oxide layer was observed.

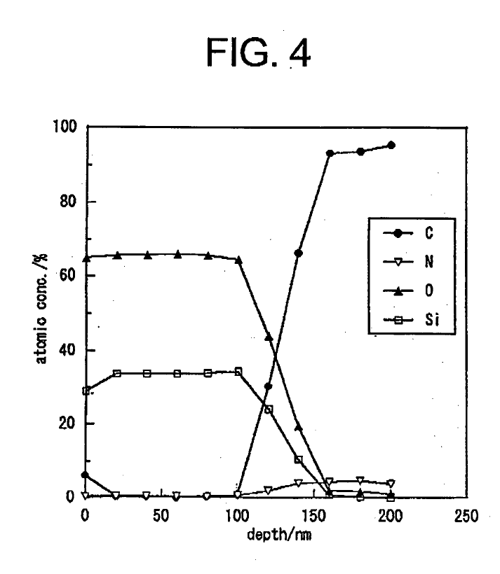

The polyimide complex sheet was then subjected to ESCA measurement to determine variations of contents of C, N, O and Si in the depth direction from the surface silica layer. The results are illustrated in FIG. 4. According to the results in FIG. 4, the surface silica layer had a thickness of approx. 100 nm, the intermediate layer comprising a mixture of silica and polyimide had a thickness of approx. 60 nm.

### COMPARISON EXAMPLE 1

The procedures for manufacturing a polyimide complex sheet described in Example 1-(2) were repeated except for coating an aminosilane coupling agent (N-phenyl-γ-aminopropyltrimethoxysilane) in place of the sol solution, to give a polyimide complex sheet having a thickness of approx. 50 μm was manufactured.

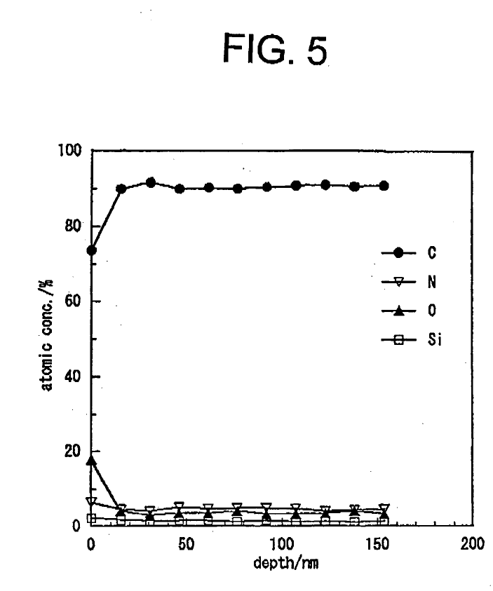

The polyimide complex sheet was then subjected to ESCA measurement to determine variations of contents of C, N, O and Si in the depth direction from the surface silica layer. The results are illustrated in FIG. 5. According to the results in FIG. 5, neither silica layer nor intermediate layer comprising a mixture of silica and polyimide were formed.
elastic modulus in tension: 5.8 GPa
tensile strength at break: 280 MPa
elongation at break: 23%
grid peeling test: exfoliation of the metal oxide layer was observed.

### COMPARISON EXAMPLE 2

The procedures for manufacturing a polyimide complex sheet described in Example 1-(2) were repeated except for coating the sol solution on a polyimide film of Reference Example 1, to give a polyimide complex sheet having a thickness of approx. 50 μm was manufactured.

The polyimide complex sheet was then subjected to ESCA measurement to determine variations of contents of C, N, O and Si in the depth direction from the surface silica layer. According to the results, no intermediate layer comprising a mixture of silica and polyimide were formed.
grid peeling test: exfoliation of the metal oxide layer was observed.

### EXAMPLE 4

(1) Preparation of Coating Sol Solution

The procedures of Example 2-(1) were repeated except for employing 5.05 g of water, to give a sol solution.

(2) Manufacture of Polyimide Complex Sheet

The procedures for manufacturing a polyimide complex sheet described in Example 1-(2) were repeated except for employing the sol solution obtained above, to give a polyimide complex sheet having a thickness of approx. 50 μm was manufactured. The resulting complex sheet had properties and a structure similar to those observed in Example 2.

### EXAMPLE 5

(1) Preparation of Coating Sol Solution

The procedures of Example 2-(1) were repeated except for replacing 4.9 g (0.056 mol) of N,N-dimethylacetamide with 2.6 g (0.056 mol.) of ethanol, to give a sol solution.

(2) Manufacture of Polyimide Complex Sheet

The procedures for manufacturing a polyimide complex sheet described in Example 1-(2) were repeated except for employing the sol solution obtained above, to give a polyimide complex sheet having a thickness of approx. 50 μm was manufactured. The resulting complex sheet had properties and a structure similar to those observed in Example 2.

1. A polyimide complex sheet comprising an aromatic polyimide film and a thin metal oxide layer in which an intervening layer comprising a mixture of the metal oxide and the aromatic polyimide under such condition that a ratio of the metal oxide to the aromatic polyimide increases from a side facing the polyimide film to a side facing the metal oxide layer is arranged between the polyimide film and the metal oxide layer, the intervening layer being united to the polyimide film and the metal oxide layer under such condition that the metal oxide layer is not peelable from the polyimide film without breakage of the metal oxide layer.

2. The polyimide complex sheet of claim 1, wherein the thin metal oxide layer has a thickness of 1 to 300 nm and the intervening layer has a thickness of 10 to 300 nm.

3. The polyimide complex sheet of claim 2, wherein the polyimide film has a thickness of 3 to 200 μm.

4. The polyimide complex sheet of claim 1, wherein the aromatic polyimide comprises an aromatic tetracarboxylic acid unit selected from the group consisting of 3,3′,4,4′-biphenyltetracarboxylic acid unit, 2,3,3′,4′-biphenyltetracarboxylic acid unit, 3,3′,4,4′-benzophenonetetracarboxylic acid unit, 3,3′,4,4′-diphenylethertetracarboxylic acid unit, bis(3,4-dicarboxyphenyl)methane unit, 2,2-bis(3,4-dicarboxyphenyl)propane unit, pyromellitic acid unit, 1,4,5,8-naphthalenetetracarboxylic acid unit and 3,4,9,10-perylenetetracarboxylic acid unit, and an aromatic diamine unit selected from the group consisting of 4,4′-diaminobenzene unit, 4,4′-diaminodiphenyl ether unit, 3,3′-diaminodiphenyl ether unit, 2,2-bis[4-(4-aminophenoxy)phenyl]propane unit, 1,3-bis(3-aminophenoxybenzene) unit, 1,3-bis(4-aminophenoxybenzene) unit and dimethylphenylenediamine unit.

5. The polyimide complex sheet of claim 1, wherein the metal oxide is silica.

6. The polyimide complex sheet of claim 1, which has an elongation at break of 80% or higher based on an elongation at break of the aromatic polyimide film.

7. The polyimide complex sheet of claim 1, which has an elongation at break of 15% or higher.

8. The polyimide complex sheet of claim 1, which has an elastic modulus in tension of 80% or higher of an elastic modulus in tension of the aromatic polyimide film.

9. The polyimide complex sheet of claim 1, which has an elastic modulus in tension of 4.5 GPa or higher.

10. The polyimide complex sheet of claim 1, which has an elastic modulus in tension of 5.3 GPa or higher.

11. A process for manufacturing a polyimide complex sheet of claim 1, which comprises the steps of:
preparing an aromatic polyimide precursor film comprising an aromatic polyamic acid and a polar organic solvent;
preparing a sol solution by hydrolyzing and condensing at least one metal-containing compound of the following formula:
R¹ₙM(OR²)ₘ₋ₙ
in which R¹ is a non-hydrolyzable group, R² is a hydrocarbyl group having 1 to 5 carbon atoms, M is a metal atom, m is a valency of the metal atom, and n is an integer satisfying the condition of 0≦n<m-1, in an aqueous organic solvent;
coating the sol solution on the aromatic polyimide precursor film; and
heating the aromatic polyimide precursor film coated with the sol solution to convert the aromatic polyimide precursor film into an aromatic polyimide film.

12. The process of claim 11, wherein the aromatic polyimide precursor film has an imidation ratio in the range of 8 to 50%.

13. The process of claim 11, wherein the polar organic solvent is N,N-dimethylacetamide.

14. The process of claim 11, wherein the aromatic polyimide precursor film comprises 20 to 40 wt. % of the polar organic solvent.

15. The process of claim 11, wherein M in the formula is Si.

16. The process of claim 11, wherein the sol solution contains the metal-containing compound in an amount of 0.1 to 5 wt. % in terms of a metal oxide content.

17. The process of claim 11, wherein the aromatic polyimide precursor film comprises an aromatic tetracarboxylic acid unit selected from the group consisting of 3,3′,4,4′-biphenyltetracarboxylic acid unit, 2,3,3′,4′-biphenyltetracarboxylic acid unit, 3,3′,4,4′-benzophenonetetracarboxylic acid unit, 3,3′,4,4′-diphenylethertetracarboxylic acid unit, bis(3,4-dicarboxyphenyl)methane unit, 2,2-bis(3,4-dicarboxyphenyl)propane unit, pyromellitic unit, 1,4,5,8-naphthalenetetracarboxylic acid unit and 3,4,9,10-perylenetetracarboxylic acid unit, and an aromatic diamine unit selected from the group consisting of 4,4′-diaminobenzene, 4,4′-diaminodiphenyl ether, 3,3′-diaminodiphenyl ether, 2,2-bis[4-(4-aminophenoxy)phenyl]propane, 1,3-bis(3-aminophenoxybenzene), 1,3-bis(4-aminophenoxybenzene) and dimethylphenylenediamine.

18. The process of claim 11, wherein the aqueous organic solvent comprises an hydrophilic organic solvent selected from the group consisting of alcohols, amides, ketones, and ethers.

19. The process of claim 11, wherein the step for heating the aromatic polyimide precursor film coated with the sol solution is performed at a highest temperature in the range of 370 to 550° C.
